(19) United States
(12) Patent Application Publication
(10) Pub. No.: US 2015/0007184 A1
(43) Pub. Date: Jan. 1, 2015

(54) QE

(71) Applicant: Alfred M. Haas, Oakhurst, NJ (US)

(72) Inventor: Alfred M. Haas, Oakhurst, NJ (US)

(21) Appl. No.: 14/215,029

(22) Filed: Mar. 16, 2014

Related U.S. Application Data
(60) Provisional application No. 61/786,852, filed on Mar. 15, 2013.

(51) Int. Cl. G06F 9/48

(52) U.S. Cl. CPC G06F 9/4881; G06F 2209/486
USPC 718/102

(57) ABSTRACT

The instant invention is related to methods and means of queuing and managing queues. Some embodiments of the methods and means of the invention incorporate functionality including, but not limited to communication, sensing, display and data processing elements. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/786,852 (“the '852 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '852 provisional and expressly incorporates by reference the disclosures contained therein in their entirety, including but not limited to all patents, patent applications, and publications which are incorporated by reference in the '852 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system. Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: smart and other scales, computers, smart phones, PDAs, other commercially available electronic devices such as tablet PCs, netbooks, e-readers (e.g., Kindle™ and Nook™), pagers, alarms, beepers, cell phones, hearing aids, watches comprising integrated and/or discrete circuits, monitors and displays, televisions, calculators, iPods™ and MP3 players, radios and stereos, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, DSPs, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, radio frequency identification (“RFID”) devices, near-field communication (“NFC”) devices, coils, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, and other circuits and systems comprised of circuits.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of some embodiments of the disclosed invention—including, but not limited to, wearable and other mobile devices, software and hardware such as sensors and transducers, transmitters, receivers and other circuits, housings, optics, programmable logic elements and chips, custom ASICs, electrical and mechanical switches, electrical and mechanical regulators, etc.: Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Elements of Information Theory, by Thomas M. Cover and Joy A. Thomas, published by Willey Interscience, copyright 1991; Information Theory and Reliable Communication, by Robert G. Gallager, published by John Wiley and Sons, copyright 1968; Principles of Communication Engineering, by John M. Wozencraft and Irwin Mark Jacobs, published by Waveland Press, copyright 1965; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The instant invention is related to methods and means of queuing and managing queues.

### BRIEF DESCRIPTION OF THE SEVERAL VIEWS OF THE DRAWINGS

### Detailed Description of the Invention

The instant invention is directed to new methods and means of queuing and managing queues. Some embodiments of the methods and means of the invention incorporate functionality including, but not limited to communication, sensing, display and data processing elements.

Some embodiments of the invention comprise a personal device and a scheduling station. In some such embodiments, a personal device comprises a cell phone. In some such embodiments, a personal device is a portable and/or wearable device comprising a communications module. In some embodiments a personal device may comprise a processing unit, a power supply and one or more means for generating and/or transmitting an alert signal. As a specific example of such an embodiment, a personal device may comprise a microcontroller, an RF communication module (e.g. Bluetooth or WiFi chip+antenna), rechargeable batteries, and a speaker. With respect to such an embodiment, one example of a method of the invention comprises the steps of: (1) a user invoking a command (e.g. by pressing one or more buttons on the personal device) to send a signal to a scheduling station indicating the user's desire to enter the queue; (2) the scheduling station receiving the signal and inserting the user into the queue; (3) the scheduling station transmitting a confirmation signal to the personal device indicating the user has successfully entered the queue and in some embodiments, communicating additional information such as the user's position in the queue and estimated time at which the user will reach the front of the queue; (4) the scheduling station interacting with other users and updating the queue as users arrive at the front of the queue and check in/out; (5) repeating the process; and (6) where appropriate reinserting a delinquent user into the queue, in some embodiments with a penalty for delinquency.

In some embodiments comprising a scheduling station, when a user reached the front of the queue, he might check in with the scheduling station and/or check out of and exit the queue; these steps might occur automatically in some embodiments. In some embodiments, a user might not be permitted re-entry into a queue for a period of time following a missed check-in and/or following a delinquent response to a scheduling station request, invitation, or other communication. Communications between a personal device and a scheduling station may be by wired or wireless transmission means, although RF such as Bluetooth and WiFi are ubiquitous in cell phones and so provide an easy means of local wireless communication without the need for an individual seeking to use the system to purchase any additional hardware—he or she can simply download the app and then check in/dock with the scheduling station and be in queue.

In some embodiments, a scheduling station comprising a processing unit and a communications module (e.g. a laptop PC or a Raspberry Pi) runs a scheduling program, connects to the internet and/or personal devices using conventional networks such as Bluetooth, WiFi, Ethernet or via proprietary communications systems comprising RF, infrared, ultrasonic, or other wired or wireless communications means, and arbitrates/manages both network traffic as well as updates the queue, for example when a user arrives at the front of the line and leaves the queue and/or otherwise departs.

In some embodiments, the electronic or virtual queue may be vastly more efficient than conventional queuing. For example, in some embodiments a user may check into a queue from a remote location using the internet and plan his arrival at the physical location based on an estimated wait time provided by the scheduling station. According to one example of such an embodiment, a trip to the DMV could be turned from a death march into an estimated appointment time. If a user mistimed the actual arrival time, or if the scheduling station provided an inaccurate estimate of the correct arrival time, he could be reinserted into the queue with an appropriate penalty at the discretion of the scheduling station. In the case where the scheduling station were automated, a rule could be implemented to assign a penalty proportional to any number of factors including but not limited to arrival time and prior place in the queue. In the case where a scheduler was partially automated and/or supervised by a human operator, similar accommodations may be made.

Likewise, in some embodiments, a user may enter a queue from a parking lot of a restaurant or other establishment. A person waiting for the doorbuster Black Friday deal at the local retail outlet may, according to some embodiments, drive to the location at a prescribed time, check in with the scheduling station to retrieve a virtual “number” and return home until the doors opened. In such a manner, some of the incidents (such as tramplings and fisticuffs) related to frenzied masses at the gates might be averted. As yet another example, a user may pre-order a restaurant meal for a specified reservation and then synchronize arrival and meal time so that both establishment and user could be satisfied more efficiently. Doctors' appointments can be updated in real-time with little more than a text message required to convey delays and/or openings. In some embodiments, a user may schedule every appointment, errand, and chore using a single computer application which in some embodiments are operated on, from or using a cell phone.

In some embodiments a scheduling station may comprise a server which may in some embodiments be remote from the physical site for which a user is queuing. In some embodiments, a user of the instant invention may be a person; in some embodiments a user may be an agent, human or otherwise (e.g., a robot, a cell phone application, a hardware embedded algorithm, a clever chimpanzee, etc . . . ), capable of invoking or performing one or more of the methods and/or employing one or more of the means of embodiments of the instant invention.

In some embodiments, a user might be able to enter a queue on site, for example by connecting with a scheduling station via NFC, and then depart the vicinity of the site until contacted, e.g. via SMS, text message, e-mail, or other wireless protocol indicating the user had arrived at or was approaching the front of the queue.

In some embodiments of the invention, personal devices are wearable and may be optionally attached to the clothing or accessories of a user. As one specific example of such an embodiment, a personal device may comprise a bracelet or wrist band with an embedded transmitter/receiver (“transceiver”) capable of receiving a signal from the scheduling station, and also capable of transmitting a signal back to the scheduling station.

Scheduling may be accomplished by any number of algorithms, including but not limited to first-in-first-out and priority queuing based on urgency, need, and/or loyalty. For example, shoppers who frequent a store more often and/or who carry a preferred customer card may receive higher priority on a priority-driven queue. As another example, senior citizens and/or infirm or disabled individuals might receive need or urgency based priority at the DMV. Algorithms and/or formulas may be implemented by in hardware, software, by one or more human beings, by other entities (think chicken playing tic-tac-toe, or an AI generating optimal path), and/or by some combination of hardware, software and/or one or more human beings or entities. Adaptations and/or changes to formulas may be deterministic, stochastic, and/or determined by a neural network or AI.

As another specific example, in some embodiments, a scheduling station may be programmed to compute and/or assign a value or a score to individuals, other entities, things and/or places according to a formula. In some embodiments of the instant invention, formulas may be fixed, programmable, adaptive and/or learning formulas that may change as a function of environmental conditions including, but not limited to, temperature, humidity, and/or air pressure, and which may also change in response to feedback, which may be generated or occur automatically, may be generated by a user, or otherwise.

Some embodiments of the invention comprise a wireless transceiver. Some embodiments of the invention comprise a global positioning system (“GPS”) device. Some embodiments of the invention comprise sensors including for example, optical sensing means such as an active pixel camera. In some embodiments, a personal device may comprise a cell phone and/or software. In some such embodiments, a cell phone may be used either independently or in conjunction with other hardware, software, and/or entities to locate entities, places and/or things. In some embodiments a personal device may be in a vehicle. In some embodiments, a personal device comprises a cane. In some embodiments a personal device comprises crutches and in some embodiments a personal device comprises a walker. In some embodiments, a personal device comprises a pair of shoes, including all forms of footwear. In some embodiments a personal device comprises other clothing. In some embodiments a personal device comprises other hardware, including for example but not limited to a an iPad, a tablet PC, an other computer, and/or a network of hardware and/or software.

In some embodiments, when a user is determined to be within a prescribed distance from a scheduling station, the scheduling station may transmit an invitation to the user to join the queue. Proximity may be inferred in some embodiments from wireless signal strength and/or by other sensors, for example including but not limited to optical and ultrasonic sensors.

In addition, in some embodiments, a device comprising software and/or hardware may be programmed and/or built to periodically poll, ping, survey or otherwise communicate with other devices, with sensors, with a network server, with a local hot spot, with markers, with beacons, and/or with other software and/or hardware in a vicinity to join and/or arbitrate the queue. There are many other ways in which embodiments of the invention may be realized, including, but not limited to computer hardware devices which can identify and/or locate queues and criteria in the vicinity via RF, IR, or other electromagnetic or optical or sonic transceivers, or networked devices such as smart cell phones communicating on a dedicated frequency band or bands, or through the internet.

In some embodiments of the invention, processing units comprise microcontrollers. In some embodiments, a processing unit may comprise one or more of a display driver, speaker drivers, input channels, power conditioning circuits, memory, and power supply regulation circuitry. In some embodiments, a processing unit may comprise additional hardware and/or software for performing other functions including but not limited to processing and transmitting data, processing and transmitting power, storing and retrieving data, receiving and decoding voice commands, generating signals including but not limited to text, graphics, and speech, as well as for such miscellaneous functions as, e.g. waking and sleeping. In some embodiments, a processing unit comprises custom integrated circuits; in some embodiments the processing unit comprises discrete circuits. In some embodiments, a processing unit comprises a combination of hardware and/or software.

In some embodiments of the invention, a processing unit comprises a communications module—for example, a transceiver with antenna for communicating with other circuits, components, devices, systems, networks and individuals. In some embodiments, a communications module may be used to transmit and receive data such as, e.g. a signal from an RF transmitter, digital GPS coordinates, queue data, firmware and software updates, as well as other data (e.g., the time and date, weather conditions, etc . . . ). In some embodiments, a communications module may comprise an antenna and/or coil for transmitting and/or receiving EM signals. A communications module may be integrated with the processing unit and/or comprise a separate component that may in some embodiments communicate with the processing unit. A communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc . . . ). It may also communicate via wires which are not illustrated, for example using one of a variety of USB cables. In addition, a communications module may include speakers and/or microphones and associated circuits for receiving and decoding voice commands and for generating sounds, including but not limited to speech. A communications module may also be integrated with the power supply—for example by capturing, harvesting and/or storing ambient or transmitted energy from an EM signal.

Some embodiments comprise means for communicating information to a user. For example, some embodiments comprise means for producing vibration and/or low frequency compression waves, such as vibrating motors. Some embodiments may comprise one or more lights, including but not limited to arrays of lights such as an LCD or LED display. For example, some embodiments comprise OLED (organic light emitting diode) screens like those found in modern cell phones and tablet PCs. However, as used in the context of this invention, displays are not intended to be limited to a single or even to existing technology—at the time this specification was written, additional examples of displays comprised, but were not limited to, the following: liquid crystals, thin film transistors, incandescent lights, fluorescent lights, halogen lights, light emitting diodes, organic light emitting diodes, lasers, fiber optics, color-changing polymers, pigmented fluids, solutions and mixtures, functionalized micro-beads, and e-inks

In some embodiments, a personal device may operate in conjunction with and/or be capable of transmitting data to and/or receiving data from an external device, system, or network using wires and/or wireless transmission methods. Illustrative examples of external devices comprise, but are not limited to, home alarms, cell phones, tablet computers, PDAs, e-readers (e.g. Kindle™ and Nook™), hearing aids, laptop and desktop computers, monitors and displays, televisions, calculators, iPods™ and MP3 players, radios and stereos, watches with electrical circuits, remote controls, bar code readers, keyboards, cameras, other input devices, data acquisition systems, other electrical devices comprising, e.g., microcontrollers, programmable interface controllers, digital signal processors, memories, field programmable gate arrays, discrete circuits, and other electrical circuits and hardware, including custom application specific integrated circuits (ASIC). In some embodiments of the instant invention, portions of residences and/or commercial establishments having appropriate circuitry (e.g. microcontrollers, DSPs, transceiver modules, input devices, etc . . . ) may comprise external devices and/or systems as defined herein. In addition, the world-wide-web, the Verizon™ wireless 4G LTE™ cellular network, and LANs are three illustrative examples of networks.

A personal device according to some embodiments of the instant invention may obtain data via wireless transmission between hardware (e.g. sensors, or an onboard microcontroller, or other processor) external to the device and a transmitter and/or receiver in the device. In some embodiments, a personal device may obtain data via wires (which may be metal or other conductive material, such as polymer), having uninsulated portions contacted to one or more surfaces of the personal device and which may be contacted to conductive surfaces such as other wires. Rechargeable batteries may be charged by a number of means including but not limited to wirelessly by harvesting EM signals and via wires.

A personal device may comprise software and/or hardware—for example a system comprising a cellular phone running an application (“app”) comprises a personal device according to some embodiments of the instant invention.

In some embodiments, the process of queuing individuals may comprise one or more of the following steps: detecting, measuring, recording, receiving, collecting, and/or retrieving data; searching data; detecting a signal and/or an event; registering the existence of condition or event; classifying data; analyzing data; sorting data; estimating likelihoods; manipulating data; processing data; storing data; reading and/or writing data; transmitting and/or receiving data; binning data; reducing the dimensionality of data; discriminating data; comparing data; learning from data; recognizing patterns in data; predicting events based on data; as well as many other forms of analysis, manipulation and other processing of data.

In some embodiments, data may be gathered and transmitted by devices possessed and/or employed by users and/or entities. As an example, a business owner might deploy an embedded image sensor in a storefront billboard to, in conjunction with other software and/or hardware, detect when preferred customers entered the premises, entering them into a queue automatically on recognition. Such data may be transmitted locally for example to other devices in range, to a local server, etc . . . and/or through the internet to one or more servers or other networked hardware and/or software.

In some embodiments, the invention may be practiced on a peer-to-peer network of mobile devices, such as cell phones, smart phones, PDAs, netbooks, and/or other portable devices capable of wireless transmission and/or receipt of data. For example, a user may specify selected criteria to an application running on and/or embedded in the hardware of a device, and one or more such devices, in some cases in conjunction with additional hardware and/or software (e.g., PCs, smart billboards, savvy traffic lights with integrated transmitters and/or receivers, etc . . . ) can be used to practice some embodiments of the method of the invention. As a more specific example, a traffic light can interact with a personal device in a vehicle to indicate when a light will turn green and that no one in the vicinity of an intersection is on course to block the vehicle's anticipated trajectory.

In some embodiments of the invention, data including but not limited to queue updates may be transmitted to a personal device periodically. In some embodiments, data may be transmitted to a personal device on the occurrence of an event, such as a user pressing a button, starting a car, or turning a vehicle off and locking a home, an enclosure or a car.

In some embodiments of the instant invention, a user may transmit data to a personal device via an input means. Examples of input means for some embodiments of the instant invention include, but are not limited to, bar code readers and other optical input devices; real, touch and virtual keyboards; RFID tag detectors and/or decoders; radio, IR, visible light and/or other EM transmitters and/or receivers, microphones and decoding systems for spoken words, microphones and decoding systems for sound transmissions other than spoken words, optical sensors (including cameras and associated classification hardware and/or software), chemical sensors (e.g. to detect alcohol or other readily identifiable chemical compounds), as well as advanced scientific instruments (e.g. mass spectrometers, DNA sequencing instruments, NMR machines, etc . . . ). Input means may be a part of a personal device, may be physically and/or electrically attached to a personal device, and/or may be separate from a personal device.

Salient queue and other data may be stored in any accessible format and any form of memory, including but not limited to, written and printed media, magnetic storage media such as hard drives and tape drives and cassettes, optical storage media such as vinyl records, CDs, DVDs, and Blu Ray discs, electronic memory such as RAM, ROM, EEPROM, flash memory, and other solid state memories, analog floating gate memory, capacitive memories, chalcogenide memories, memristor-based memories, and any other existing form including human memory of individuals. In addition, there is literally an infinite number of variations to queuing algorithms and parameters that may be used to schedule individuals; examples of basic scheduling algorithms may be found in the Cover textbook referenced in this specification and incorporated herein by reference.

It is possible to perform the steps of storing, processing, transmitting, receiving and/or displaying or otherwise outputting data or other information using a personal device in many ways. In some embodiments, one or more of the steps of queuing users may be performed by some combination of software and/or hardware without human supervision or assistance. Some automated and other embodiments may require that a human user invoke the method in some fashion, e.g., by docking the personal device with a scheduling station, turning a device on, running an application, clicking a button or tapping a personal device, speaking a command, etc., and some automated and other embodiments may perform without a human user explicitly invoking the method. For example, a system may be programmed (in software and/or hardware) to begin operation upon the occurrence of some triggering event or events and/or the satisfaction of one or more conditions. In a more specific example, a smart phone queuing application might be programmed to automatically insert a user into a queue for a table once a user crossed a threshold, e.g. of a restaurant and/or a valet parking kiosk in front of an establishment; such an application can also be programmed to request the valet enter a user into the queue to retrieve his keys and vehicle once the user exited the establishment.

Other embodiments of the method may be partially automated, with some aspects of the method performed by software and/or hardware, and other aspects performed by or in conjunction with one or more individuals. As an example, a human user enters restaurant criteria into a GUI on his smart phone which is transmitted wirelessly according to a protocol to a system comprising software and/or hardware, such as a computer server running a program, that collects, monitor and/or analyze data (e.g., criteria, locations, sensor readings, other data etc . . . ) from one or more users, entities and/or other sources, to queue individuals according to availability, preferences and interest.

In addition, there are some embodiments where one or more of the steps of the invention may be performed by one or more individuals, using data obtained from, provided by and/or generated by hardware and/or software systems. Some embodiments in which the steps of the method are performed by one or more individuals may involve a service component, but such methods do not preclude the use of technology, for example, to identify optimal arbitration schemes. As a specific example of such an embodiment, a scheduling station server may ascertain and transmit an efficient schedule over a network to a system comprising computer software and/or hardware, which will provide this information for one or more human operators to observe and/or analyze. An operator could then supervise the queue making adjustments and/or modifications at her discretion. In such embodiments, although software and/or hardware might be used to perform one or more of the steps of the method of the invention, one or more human operators might also perform some of the steps. For example, a social director at a singles dating event might schedule interactions between participants according to a FIFO algorithm weighted according to age and compatibility and biased to balance gender.

In some embodiments of the invention, measured, ascertained and/or computed data may be transmitted and/or received by and/or retrieved by a personal device and/or other system comprising software and/or hardware. Such data may include, for example, but is not limited to: absolute location information, e.g. GPS coordinates; relative location information, e.g. grid coordinates; the distance or proximity between an entity, place or thing and a user and/or a device worn, carried by, or otherwise proximate to a user; the relative location of an entity, place or thing with respect to a user and/or to a device proximate to a user;; the date; the time; environmental conditions such as weather, temperature, humidity and altitude; and other data relevant to the methods and means of the invention, Individual users and/or entities may elect to transmit or to have certain data concerning themselves transmitted to and/or retrieved by such a system. In some embodiments, a personal device and/or other system may ascertain data by one or more means including for example, but not limited to, measuring it, generating or observing it (e.g. pseudo-random numbers), retrieving it from memory, receiving it from users and/or entities via an input means, receiving it from external devices, software and/or hardware, including storage media; receiving it through a network such as the world-wide-web, retrieving it from publicly accessible or private disclosed records, extracting it from software and/or hardware employed by a user and/or entity, sensing it, and/or from any other accessible source. In addition, in some embodiments, a database or collection of data pertaining to users, things, entities and/or locations may be maintained (e.g., on the hard drives of a network server or other hardware), which in some situations eases the computational and/or bandwidth load for the system so that only data which changed, e.g. user/entity/thing location, might be transmitted and/or detected on a repeated basis.

In some embodiments of the invention, transmission and receiving may be by an existing wireless digital protocol (see below), by a custom or future wireless protocol, by analog radio frequency or other EM spectrum (including but not limited to visible, IR, and UV light) transmission, by sound, or any other means of wireless transmission, or via wires, cables, and transferable storage media such as flash drives and data cards.

Various embodiments of the invention may be practiced in many ways, including for example, but not limited to, in real-time, continuously, periodically, regularly, on a schedule, at some prescribed intervals or times, with a given refresh and/or update rate, clocked, and/or asynchronously in an event-driven fashion. Event-driven broadly means triggered by or otherwise correlated in time or sequence with the occurrence of an event. Events include, but are not limited to, the detection of an entity, place and/or thing meeting certain criteria and/or satisfying certain conditions, the recognition that an entity, place and/or thing meets certain criteria and/or satisfies certain conditions, an entity crossing a threshold such as a boundary between a vicinity and an area outside that vicinity, the satisfaction of one or more environmental or other conditions, reaching a detected threshold value or level, the occurrence of something, a change in state, and other discernible occurrences.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A method for managing queues. comprising the steps of: (1) inserting users into a queue; (2) keeping track of users in the queue and keeping track of data pertaining to users in the queue; and (3) updating the queue when users complete and/or exit the queue; and (4) alerting users to pertinent information concerning the queue and their status.

2. The method according to claim 1 wherein the steps of the method are performed by a system comprising a scheduling station comprising hardware and/or software.

3. The method according to claim 2 further comprising the steps of: a user invoking a command to send a signal to a scheduling station indicating the user's desire to enter the queue, and the scheduling station receiving the signal and transmitting a confirmation signal to a personal device of the user when the user has been inserted into the queue.

4. The method according to claim 1 further comprising the step of: automatically inserting a user into a queue according to a rule following the satisfaction of one or more events or conditions.

5. The method according to claim 2, wherein the scheduling station communicates alerts to users concerning the queue and their status.

6. The method of claim 2 further comprising the steps of reinserting a user into the queue after he has exited or been removed from the queue.

7. A means for managing queues comprising at least one personal device and a scheduling station.

8. The means for managing queues of claim 7, wherein said personal device comprises a mobile communication device.

9. The means of claim 8 wherein the mobile communication device comprises one or more of the following: earrings, a ring, a cell phone, a pendant, a piercing, a watch, a tablet PC, a hearing aid, and a wristband.

10. The means of claim 7 wherein the personal device comprises a processing unit, a power supply and one or more means for generating and/or transmitting an alert signal.
